(19) United States
(12) Patent Application Publication
(10) Pub. No.: US 2014/0185605 A1
(43) Pub. Date: Jul. 3, 2014

(54) METHOD AND APPARATUS FOR REDUCING CHANNEL SCANNING TIME BY SHARING CHANNEL INFORMATION IN WIRELESS LOCAL AREA NETWORK (WLAN)

(71) Applicant: ELECTRONICS AND TELECOMMUNICATIONS RESEARCH INSTITUTE, DAEJEON (KR)

(72) Inventors: Sae Hun OH, Daejeon (KR); Sok Kyu LEE, Daejeon (KR)

(73) Assignee: ELECTRONICS AND TELECOMMUNICATIONS RESEARCH INSTITUTE, DAEJEON (KR)

(21) Appl. No.: 14/146,690

(22) Filed: Jan. 2, 2014

(30) Foreign Application Priority Data
Jan. 2, 2013 (KR) 10-2013-0000073

(51) Int. Cl. H04W 8/00; H04W 84/12

(52) U.S. Cl. CPC H04W 8/005; H04W 84/12
USPC 370/338

(57) ABSTRACT

A method and apparatus for scanning a channel in a wireless local area network (WLAN) system may be disclosed including, extracting at least one target channel from among a plurality of channels present in at least one frequency band, based on channel scanning record information, generating a basic service set (BSS) existing information element (IE) including at least one BSS existing channel bitmap indicating information associated with a channel in which at least one access point (AP) exists, based on channel information received from at least one neighboring station (STA), determining a scanning rank of the at least one target channel, using the BSS existing channel IE, and identifying a target AP through scanning the at least one target channel, based on the scanning rank.

### CROSS-REFERENCE TO RELATED APPLICATION

This application claims the priority benefit of Korean Patent Application No. 10-2013-0000073, filed on Jan. 2, 2013, in the Korean Intellectual Property Office, the disclosure of which is incorporated herein by reference.

### BACKGROUND

1. Field of the Invention

The present invention relates to a method and apparatus for reducing a channel scanning time by sharing channel information in a wireless local area network (WLAN), and more particularly, to a method and apparatus for reducing a channel scanning time, based on channel information received from a neighboring station (STA).

2. Description of the Related Art

With development in information and communication technology (ICT), varied forms of wireless communication technology are also under development. A wireless local area network (WLAN) refers to technology for wirelessly connecting to the Internet at residential, corporate, or predetermined service providing areas, using a portable station (STA), for example, a personal digital assistant (PDA), a smart phone, a laptop computer, a portable multimedia player (PMP), and the like, based on wireless frequency technology.

Currently, a WLAN may provide a 2.4 gigahertz (GHz) band and a 5 GHz band, and differ based on areas. However, in terms of standards established in the Republic of Korea, 11 channels are included in the 2.4 GHz band, and 25 channels are included in the 5 GHz band. A plurality of STAs may scan channels providing a WLAN and obtain information on an access point (AP) in order to connect to the WLAN. In recent times, research into initiating a more rapid connection to WLAN is being conducted to enhance user efficiency.

### SUMMARY

According to an aspect of the present invention, there is provided a method for scanning a channel in a wireless local area network (WLAN) system, the method including extracting at least one target channel from among a plurality of channels present in at least one frequency band, based on channel scanning record information, generating a basic service set (BSS) existing channel information element (IE) including at least one BSS existing channel bitmap indicating information on a channel in which at least one access point (AP) exists, based on channel information received from at least one neighboring station (STA), determining a scanning rank of at least one target channel, using the BSS existing channel IE, and identifying a target AP from among the at least one AP through scanning the at least one target channel, based on the scanning rank.

The channel scanning record information may include information on at least one channel that performed scanning from among the plurality of channels.

The at least one BBS existing channel bitmap may include at least one band indication bit indicating information on the at least one frequency band and at least one channel indication bit indicating information on a presence of a BSS in the at least one channel.

A size of the at least one BSS existing channel bitmap may correspond to a number of the plurality of channels present in the at least one frequency band.

The determining of the scanning rank of the at least one target channel, using the BSS existing channel IE may include identifying at least one BSS existing channel from among the at least one target channel, using the BSS existing channel IE, and generating the scanning rank, based on a priority of the at least one BSS existing channel.

The determining of the scanning rank of the at least one target channel, using the BSS existing channel IE may further include generating the scanning rank of the at least one target channel, using a predetermined rule when the at least one BSS existing channel is unidentifiable among the at least one target channel.

The identifying of the target AP may further include determining whether scanning channel information obtained by scanning the at least one target channel corresponds to the at least one BSS existing channel bitmap, and updating the at least one BSS existing channel bitmap, based on the scanning channel information when the scanning channel information does not correspond to the at least one BSS existing channel bitmap as a result of the determination.

The BSS existing channel IE may further include an identifier (ID) field indicating an ID of the BSS existing channel IE, and a length field indicating a length of the BSS existing channel IE.

The method for scanning the channel in the WLAN system may further include providing information on a channel in which the at least one AP exists in the at least one neighboring STA.

The providing of the information on the channel in which the AP exists to the at least one neighboring STA may include setting a receiver address of a probe request frame to be an address of the at least one neighboring STA, and transmitting the probe request frame including the BSS existing channel IE to the at least one AP.

According to an aspect of the present invention, there is provided an apparatus for scanning a channel in a WLAN system, the apparatus including a target channel extractor to extract at least one target channel from among a plurality of channels present in at least one frequency band, based on channel scanning record information, a BSS existing channel information element (IE) generator to generate a BSS existing channel IE including at least one BSS channel bitmap indicating information on a channel in which at least one AP exists, based on channel information received from at least one neighboring STA, a scanning rank determiner to determine a scanning rank of the at least one target channel, using the BSS existing channel IE, and a target AP identifier to scan the at least one target channel, based on the scanning rank, and identify a target AP from among the at least one AP.

The scanning rank determiner may include a BSS existing channel identifier to identify at least one BSS existing channel from among the at least one target channel, using the BSS existing channel IE, and a scanning rank generator to generate the scanning rank, based on a priority of the at least one BSS existing channel.

The target AP identifier may further include a determiner to determine whether scanning channel information obtained by scanning the at least one target channel corresponds to the at least one BSS existing channel bitmap, and a BSS existing channel bitmap updater to update the at least one BSS existing channel bitmap, based on the scanning channel information when the scanning channel information does not correspond to the at least one BSS existing channel bitmap as a result of the determination.

The apparatus for scanning the channel in the WLAN system may further include a channel information provider to provide channel information in which the at least one AP exists to the at least one neighboring STA.

The channel information provider may include a setter to set a receiver address of the probe request frame to be an address of the at least one neighboring STA, and a probe request frame transmitter to transmit a probe request frame including the BSS existing channel IE to the at least one AP.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a wireless local area network (WLAN) system according to an embodiment of the present invention;

FIG. 2 is a flowchart illustrating a method for scanning a channel in a WLAN system;

FIG. 3 is a diagram illustrating a basic service set (BSS) existing channel bitmap;

FIG. 4 is a diagram illustrating a BSS existing channel information element (IE); and

FIG. 5 is a block diagram illustrating an apparatus for scanning a channel in a WLAN system.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

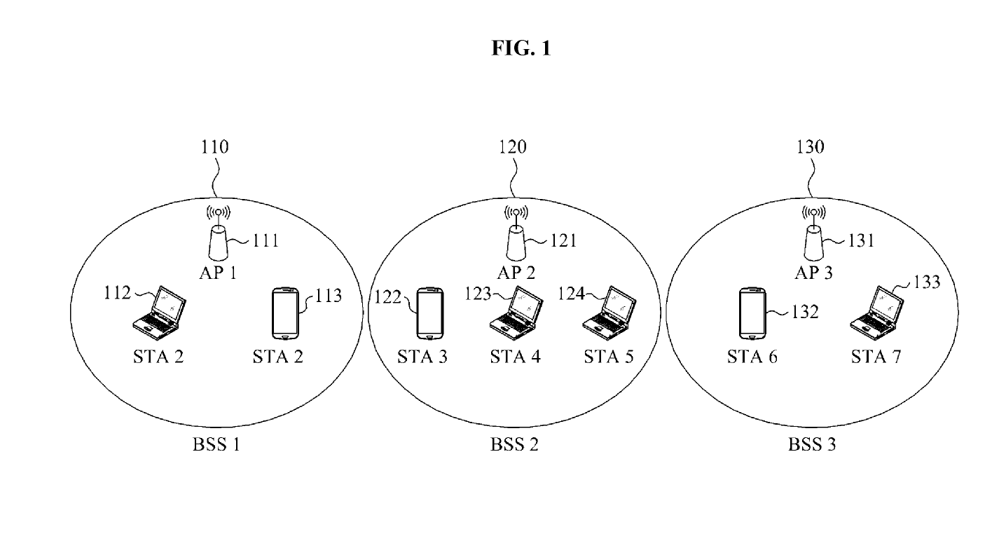

FIG. 1 is a diagram illustrating a wireless local area network (WLAN) system according to an embodiment of the present invention.

Referring to FIG. 1, the WLAN system may include at least one station (STA), at least one access point (AP), and at least one basic service set (BSS). Here, an STA refers to a predetermined function medium including a medium access control (MAC) layer interface and a physical layer interface pertaining to a wireless medium to connect to the WLAN system. An AP refers to a function medium connected to a network via a wireless medium for a connected STA. Also, the at least one BSS refers to a group of the at least one STA, and the at least one BSS may correspond to a single AP.

In particular, an STA may obtain information on an AP by scanning channels providing access to the WLAN. More particularly, the STA may obtain the information on the AP through scanning a channel, using a beacon frame periodically received from the AP. Also, the STA may scan a channel through receiving, from the AP, a probe response frame, for example, a response pertaining to a probe request frame transmitted to the AP. Accordingly, the STA may perform channel scanning up to a total of 11 times in a 2.4 GHz frequency band in which 11 channels may exist, and perform channel scanning up to a total of 42 times in a 5 GHz frequency band in which maximum 42 channels may exist in order to search for a target AP desired to be connected to because the STA may perform channel scanning to connect to the AP.

For example, a BSS 1 110 may include an STA 1 112 and an STA 2 113, and may correspond to an AP 1 111. The STA 1 112 may connect to the AP 1 111, and may not connect to an AP 2 121. However, the STA 1 112 may scan channels in which the AP 2 121 or an AP 3 131 exists in order to search for the AP 1 111.

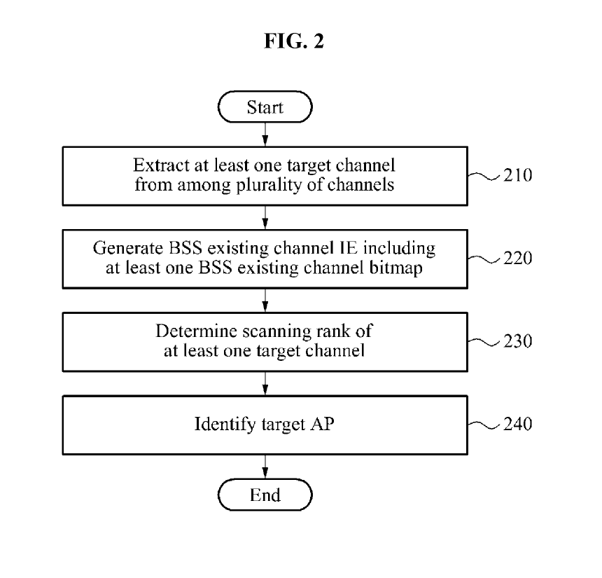

FIG. 2 is a flowchart illustrating a method for scanning a channel in a WLAN system;

Referring to FIG. 2, in operation 210, the method for scanning the channel in the WLAN system may extract at least one target channel from among a plurality of channels present in at least one frequency band, based on channel scanning record information. In particular, an STA may identify a channel in which an AP exists to identify an AP in the WLAN system. More particularly, the STA may identify a channel using passive scanning or active scanning Here, the passive scanning may refer to receiving a beacon frame transmitted by an AP while changing a provided channel. The active scanning may refer to receiving a probe response frame transmitted by at least one AP present in a channel, in response to a probe request frame, subsequent to transmitting the probe request frame to the at least one AP present in the channel via broadcasting.

The method for scanning the channel in the WLAN system may extract at least one target channel from among a plurality of channels, based on channel scanning record information for rapid channel scanning In this instance, the channel scanning record information may refer to information on a channel on which scanning is previously performed from among a plurality of channels present in at least one frequency band. Also, the method for scanning the channel in the WLAN system may set a channel on which the scanning is yet to be performed to be a target channel, based on the channel scanning record information in order to prevent unnecessary scanning such as performing scanning on the channel on which the scanning is previously performed. For one example, when an STA scans 11 channels present in the 2.4 GHz frequency band, and 5 channels of the 11 channels are assumed to be scanned in advance, the method for scanning the channel in the WLAN system may verify channels on which scanning is previously performed, based on the channel scanning record information. Further, scanning may be performed only on 6 target channels remaining on which scanning is yet to be performed among the 11 channels. Accordingly, the method for scanning the channel in the WLAN system may perform scanning a relatively more rapid pace. Also, in operation 220, the method for scanning the channel in the WLAN system may generate a BSS existing channel information element (IE) including at least one BSS existing channel bitmap indicating information on a channel in which at least one AP exists, based on channel information received from at least one neighboring STA. In particular, an STA may receive channel information from at least one neighboring STA. In this instance, the channel information may refer to information on a channel in which at least one AP exists. The at least one neighboring STA may belong to a BSS identical to a BSS of an STA performing scanning, and a BSS differing from the BSS of the STA performing scanning. More particularly, the at least one neighboring STA may recognize a channel number of channels in which at least one AP exists. Accordingly, at least one neighboring STA may set a receiver address of a probe request frame to be an address of an STA performing channel scanning, and transmit a probe request frame including a BSS existing channel IE to at least one AP. Here, the probe request frame may include the BSS existing channel IE at all times. The at least one AP may transmit a probe response frame including the BSS existing channel IE to the STA performing channel scanning, in response to the transmission of the probe request frame.

The method for scanning the channel in the WLAN system may generate a BSS existing channel IE including a BSS existing channel bitmap. In particular, management frames, such as the probe request frame and the frame response frame may include various types of IEs. Here, the probe request frame may include a service set identifier (SSID), supported rates, and at least one IE. The at least one IE may include an element ID field, a length field, and an IE field. Here, the element ID field may represent a type of IEs, the length field may represent a length of IE, and the IE may represent information on actual data.

For example, the BSS existing channel IE may include information on a channel in which a BSS exists. Accordingly, the BSS existing channel IE may include an ID field, a length field, and a BSS existing channel bitmap. Here, the BSS existing channel bitmap may refer to information on a channel in which a BSS corresponding to an AP exists. The BSS existing channel IE may include at least one BSS existing channel bitmap corresponding to a frequency. By way of example, the BSS existing channel IE may include a BSS existing channel bitmap corresponding to a 2.4 GHz band or a BSS existing channel bitmap corresponding to a 5 GHz band, or include a BSS existing channel bitmap corresponding to a 2.4 GHz band and a BSS existing channel bitmap corresponding to a 5 GHz band.

The BSS existing channel bitmap may include at least one band indication bit indicating information on at least one frequency and at least one channel indication bit indicating information on whether a BSS exists in at least one channel. A size of the at least one BSS existing channel bitmap may correspond to a number of a plurality of channels present in at least one frequency band. For example, the 2.4 GHz band may set a size of the BSS existing channel bitmap to be 2 octets because the 2.4 GHz band includes 11 channels. In an instance of the 5 GHz band in which maximum 42 channels may exist, a size of the BSS existing channel bitmap may be set to be 6 octets.

As a detailed example, an STA may obtain, from a neighboring STA 1, a BSS existing channel IE including information indicating that a channel 1 and a channel 2 in the 2.4 GHz band are BSS existing channels, and obtain, from a neighboring STA 2, a BSS existing channel IE including information indicating a channel 5 in the 5 GHz band is a BSS existing channel. Transitively, the method for scanning the channel in the WLAN system may generate the BSS existing channel bitmap and the BSS existing channel IE including the information indicating that the channel 1 and the channel 2 in the 2.4 GHz band are BSS existing channels and the information indicating that the channel 5 in the 5 GHz band is a BSS existing channel, based on the obtained BSS existing channel IEs.

Also, in operation 230, the method for scanning the channel in the WLAN system may determine a scanning rank of at least one target channel, using a BSS existing channel IE. In particular, the method for scanning the channel in the WLAN system may determine whether at least one BSS existing channel exists among the at least one target channel, using the BSS existing channel IE. When the at least one BSS existing channel is determined to exist as a result of the determination, the method for scanning the channel in the WLAN system may generate at least one scanning rank, based on a priority of the at least one BSS existing channel. When a plurality of BSS existing channels exists, the at least one scanning rank may be generated based on a predetermined rule. In one example, when channels 3, 4, and 7 from among 11 channels in a 2.4 GHz band are identified to be BSS existing channels, the method for scanning the channel in the WLAN system may perform channel scanning, based on a priority of the channels 3, 4, and 7. When the predetermined rule performs channel scanning in a sequential manner of channel number, the channel scanning may be performed in a sequence of channel 3, channel 4, and channel 7.

When the at least one BSS existing channel is determined to be unidentified as a result of the determination, a scanning rank of at least one target channel may be generated based on the predetermined rule. For example, when a BSS existing channel is determined to be absent in 42 channels in a 5 GHz band, and a predetermined rule performs channel scanning in a sequential manner of channel number, the channel scanning may be performed in a sequence from channel 1 to channel 42 in the 5 GHz band.

Also, in operation 240, the method for scanning the channel in the WLAN system may identify a target AP from among at least one AP, through scanning at least one target channel, based on a scanning rank. Here, the target AP may refer to an AP corresponding to a BSS to which an STA scanning a channel belongs. More particularly, the method for scanning the channel in the WLAN system may scan at least one target channel, based on a scanning rank. For example, when channels 1 through 7 in a 2.4 GHz band is a target channel, the method for scanning the channel in the WLAN system may perform channel scanning on the channels from 1 through 7 in a sequential manner. In this instance, when the channel 3 is a BSS existing channel corresponding to a target AP, the target AP may be identified through scanning the channel 3. The channel scanning may not be performed on the channels 4 through 7.

When a target channel is scanned, channel scanning record information may be updated with respect to a channel on which the scanning is performed. In the example above, the scanning is performed on the channels from 1 through 3, and therefore, the channel scanning record information of the channels from 1 through 3 may be updated to indicate that the channel scanning is performed on the channels from 1 through 3.

The method for scanning the channel in the WLAN system may determine whether scanning channel information obtained by scanning at least one target channel corresponds to at least one BSS existing channel bitmap. When the scanning channel information does not correspond to the at least one BSS existing channel bitmap as a result of the determination, at least one BSS existing channel bitmap may be updated, based on the scanning channel information. For example, the BSS existing channel bitmap may represent a channel 4 and a channel 7 from among 42 channels in a 5 GHz band as BSS existing channels. However, when a channel 15 is determined to be a BSS existing channel as a result of the scanning, the method for scanning the channel in the WLAN system may update a BSS existing channel bitmap to indicate that the channel 15 is a BSS existing channel. A BSS existing channel IE including the updated BSS existing channel bitmap may be transmitted to at least one AP through including the BSS existing channel IE in a probe request frame.

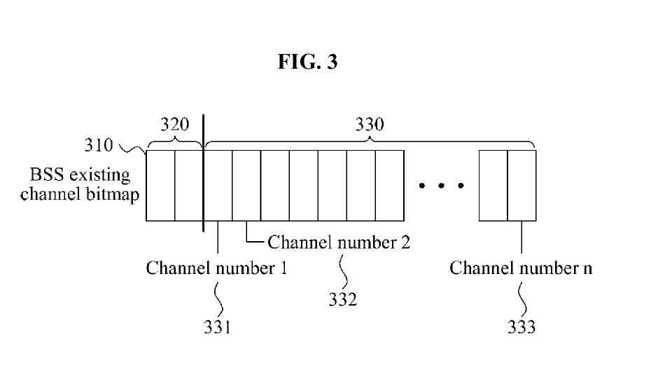

FIG. 3 is a diagram illustrating a BSS existing channel bitmap 310

Referring to FIG. 3, the BSS existing channel bitmap 310 may include at least one band indication bit 320 and at least one channel indication bit 330. In particular, the band indication bit 320 may refer to a first bit of the BSS existing channel bitmap 310, and indicate to which band of information subsequent bits belong. For one example, “0x00” may refer to information associated with a 2.4 GHz band. “0x01” may refer to information associated with a 5 GHz band. The channel indication bit 330 may refer to a bit existing subsequent to the band indication bit 320, and identify a BSS existing channel from among a plurality of channels to represent the BSS existing channel. The channel indication bit 330 may be mapped in a sequential manner of a channel 1 331 through a channel n 333. Here, the channel n 333 may refer to a final channel present in a frequency band. Accordingly, “n” may be 11 because 11 channels may exist in a 2.4 GHz band, and “n” may be 42 because 42 channels may exist in a 5 GHz band. Therefore, a size of the BSS existing channel bitmap 310 in the 2.4 GHz band may be 2 octets, and a size of the BSS existing channel bitmap 310 in the 5 GHz band may be 6 octets. In the channel indication bit 330, “1” may denote a BSS existing channel, and “0” may denote a BSS absent channel. For example, when a BSS exists in a channel 5 and a channel 7 in a 2.4 GHz band, the BSS existing channel bitmap 310 may be represented as “0 0 0 0 0 0 1 0 1 0 0 0 0”.

The BSS existing channel bitmap 310 may be generated based on channel information received from at least one neighboring STA. When scanning channel information obtained as a result of scanning a target channel does not correspond to the BSS existing channel bitmap 310, the BSS existing channel bitmap 310 may be updated based on the scanning channel information. For example, a BSS existing channel IE including information indicating that channels 1 and 2 in a 2.4 GHz band are BSS existing channels may be obtained from a neighboring STA 1, and a BSS existing channel IE including information indicating a channel 4 in a 2.4 GHz band is a BSS existing channel may be obtained from a neighboring STA 2. Transitively, the method for scanning the channel in the WLAN system may generate the BSS existing channel bitmap 310 including information indicating the channels 1, 2, and 4 in a 2.4 GHz band are BSS existing channels, and the BSS existing channel bitmap 310 may be represented as “0 0 1 1 0 1 0 0 0 0 0 0 0”. When a channel 6 is determined to be a BSS existing channel as a result of the scanning, the BSS existing channel bitmap 310 may be updated to be “0 0 1 1 0 1 0 1 0 0 0 0 0”.

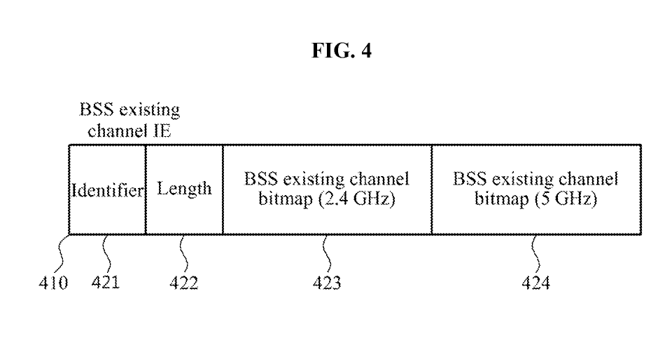

FIG. 4 is a diagram illustrating a BSS existing channel IE 410.

Referring to FIG. 4, the BSS existing channel IE 410 may include an element ID field 421, a length field 422, and at least one BSS existing channel bitmap 423 and 424. Here, the at least one BSS existing channel bitmap 423 and 424 may correspond to at least one frequency band. For example, a BSS existing channel IE indicating information associated with a channel present in a 2.4 GHz band may include a BSS existing channel bitmap 423 corresponding to a 2.4 GHz band, a BSS existing channel IE indicating information associated with a channel present in a 5 GHz band may include a BSS existing channel bitmap 424 corresponding to a 5 GHz band, and a BSS existing channel IE indicating information associated with a channel present in a 2.4 GHz band and a 5 GHz band may include the BSS existing channel bitmap 423 corresponding to a 2.4 GHz band and the BSS existing channel bitmap 424 corresponding to a 5 GHz band.

The method for scanning the channel in the WLAN system may determine a scanning rank of a target channel, using the BSS existing channel IE 410. Transitively, a target AP may be rapidly identified by performing scanning, based on a priority of a BSS existing channel.

The BSS existing channel IE 410 may be included in a probe request frame, and transmitted to at least one AP. Accordingly, scanning channel information obtained through scanning by an STA may be transmitted to a neighboring STA, and the neighboring STA may identify a target AP of the neighboring STA, using the BSS existing channel IE 410 received.

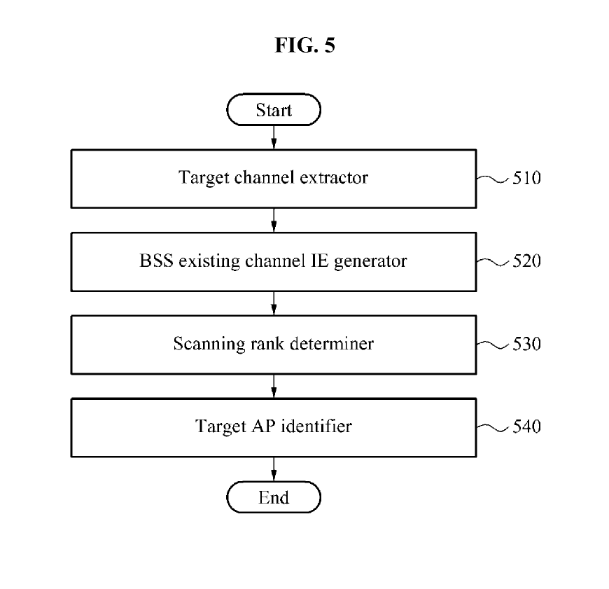

FIG. 5 is a block diagram illustrating an apparatus for scanning a channel in a WLAN system.

Referring to FIG. 5, a target channel extractor 510 may extract at least one target channel from among a plurality of channels present in at least one frequency band, based on channel scanning record information.

Also, a BSS existing channel IE generator 520 may generate a BSS existing channel IE including at least one BSS channel bitmap indicating information associated with a channel in which at least one AP exists, based on channel information received from at least one neighboring STA.

Also, a scanning rank determiner 530 may determine a scanning rank of at least one target channel, using a BSS existing channel IE.

The scanning rank determiner 530 may include a BSS existing channel identifier (not shown) for identifying at least one BSS existing channel from among at least one target channel, a scanning rank generator (not shown) for generating at least one scanning rank, based on a priority of at least one BSS exiting channel, using the BSS existing channel IE.

Also, a target AP identifier 540 may identify a target AP through scanning at least one target channel, based on a scanning rank.

The target AP identifier 540 may further include a determiner (not shown) for determining whether scanning channel information obtained by scanning the at least one target channel corresponds to at least one BSS existing channel bitmap, and a BSS existing channel bitmap updater (not shown) for updating the at least one BSS existing channel bitmap, based on the scanning channel information when the scanning channel information does not correspond to the at least one BSS existing channel bitmap as a result of the determination.

The apparatus for scanning the channel in the WLAN system may further include a channel information provider (not shown) for providing channel information in which at least one AP exists for at least one neighboring STA.

The channel information provider may include a setter (not shown) for setting a receiver address of a probe request frame to be an address of the at least one neighboring STA, and a probe request frame transmitter (not shown) for transmitting a probe request frame including the BSS existing channel IE to the at least one AP.

Descriptions of FIGS. 1 through 4 may be applied to the apparatus for scanning the channel in the WLAN system of FIG. 5, and thus, a repeated description will be omitted for conciseness.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for scanning a channel in a wireless local area network (WLAN) system, the method comprising:
extracting at least one target channel from among a plurality of channels present in at least one frequency band, based on channel scanning record information;
generating a basic service set (BSS) existing channel information element (IE) including at least one BSS existing channel bitmap indicating information on a channel in which at least one access point (AP) exists, based on channel information received from at least one neighboring station (STA);
determining a scanning rank of at least one target channel, using the BSS existing channel IE; and
identifying a target AP from among the at least one AP through scanning the at least one target channel, based on the scanning rank.

2. The method of claim 1, wherein the channel scanning record information comprises information on at least one channel that performed scanning from among the plurality of channels.

3. The method of claim 1, wherein the at least one BBS existing channel bitmap comprises:
at least one band indication bit indicating information on the at least one frequency band and at least one channel indication bit indicating information on a presence of a BSS in the at least one channel.

4. The method of claim 1, wherein a size of the at least one BSS existing channel bitmap corresponds to a number of the plurality of channels present in the at least one frequency band.

5. The method of claim 1, wherein the determining of the scanning rank of the at least one target channel, using the BSS existing channel IE comprises:
identifying at least one BSS existing channel from among the at least one target channel, using the BSS existing channel IE; and
generating the scanning rank, based on a priority of the at least one BSS existing channel.

6. The method of claim 5, wherein the determining of the scanning rank of the at least one target channel, using the BSS existing channel IE further comprises:
generating the scanning rank of the at least one target channel, using a predetermined rule when the at least one BSS existing channel is unidentifiable among the at least one target channel.

7. The method of claim 1, wherein the identifying of the target AP further comprises:
determining whether scanning channel information obtained by scanning the at least one target channel corresponds to the at least one BSS existing channel bitmap; and
updating the at least one BSS existing channel bitmap, based on the scanning channel information when the scanning channel information does not correspond to the at least one BSS existing channel bitmap as a result of the determination.

8. The method of claim 1, wherein the BSS existing channel IE further comprises:
an identifier (ID) field indicating an ID of the BSS existing channel IE, and a length field indicating a length of the BSS existing channel IE.

9. The method of claim 1, further comprising:
providing information on a channel in which the at least one AP exists in the at least one neighboring STA.

10. The method of claim 9, wherein the providing of the information on the channel in which the AP exists to the at least one neighboring STA comprises:
setting a receiver address of a probe request frame to be an address of the at least one neighboring STA; and
transmitting the probe request frame including the BSS existing channel IE to the at least one AP.

11. An apparatus for scanning a channel in a wireless local area network (WLAN) system, the apparatus comprising:
a target channel extractor to extract at least one target channel from among a plurality of channels present in at least one frequency band, based on channel scanning record information;
a basic service set (BSS) existing channel information element (IE) generator to generate a BSS existing channel IE including at least one BSS channel bitmap indicating information on a channel in which at least one access point (AP) exists, based on channel information received from at least one neighboring station (STA);
a scanning rank determiner to determine a scanning rank of the at least one target channel, using the BSS existing channel IE; and
a target AP identifier to scan the at least one target channel, based on the scanning rank, and identify a target AP from among the at least one AP.

12. The apparatus of claim 11, wherein the scanning rank determiner comprises:
a BSS existing channel identifier to identify at least one BSS existing channel from among the at least one target channel, using the BSS existing channel IE; and
a scanning rank generator to generate the scanning rank, based on a priority of the at least one BSS existing channel.

13. The apparatus of claim 11, wherein the target AP identifier further comprises:
a determiner to determine whether scanning channel information obtained by scanning the at least one target channel corresponds to the at least one BSS existing channel bitmap; and
a BSS existing channel bitmap updater to update the at least one BSS existing channel bitmap, based on the scanning channel information when the scanning channel information does not correspond to the at least one BSS existing channel bitmap as a result of the determination.

14. The apparatus of claim 11, further comprising:
a channel information provider to provide channel information in which the at least one AP exists to the at least one neighboring STA.

15. The apparatus of claim 14, wherein the channel information provider comprises:
a setter to set a receiver address of the probe request frame to be an address of the at least one neighboring STA; and
a probe request frame transmitter to transmit a probe request frame including the BSS existing channel IE to the at least one AP.
